(19) United States
(12) Patent Application Publication
(10) Pub. No.: US 2004/0246361 A1
(43) Pub. Date: Dec. 9, 2004

(54) Preview illumination for a digital camera display

(76) Inventor: Jahangir S. Rastegar, Stony Brook, NY (US)

Correspondence Address: Jahangir S. Rastegar, 2 Sipala Court, East Northport, NY, 11731, US

(21) Appl. No.: 10/457,584

(22) Filed: Jun. 9, 2003

(51) Int. Cl. H04N 5/222

(52) U.S. Cl. 348/333.11

(57) ABSTRACT

A still camera including: a display for displaying a scene; an image pickup device for displaying a preview image of the scene on the display; a storage device operatively connected to the image pickup device; a switch for selectively storing the preview image on the storage device; and an illumination device for illuminating the scene prior to storage of the preview image on the storage device where the ambient light level proximate the scene is less then that necessary to substantially view the preview image on the display.

### BACKGROUND OF THE INVENTION

1. Field of the Invention

The present invention relates generally to digital cameras, and more particularly, to a preview illumination for a digital camera display, particularly in conditions of poor ambient lighting.

2. Prior Art

Cameras are known in the art to have a preview capability. That is, the camera has a display, which allows a user to preview a scene before taking a photograph. FIG. 1 illustrates a rear view of a digital camera, referred to generally by reference numeral 100. The camera 100 includes a preview display 102, which is generally a small LCD screen on the rear of the camera. The user can utilize the LCD screen 102 to frame the subjects or objects of interest in the scene to his or her liking. The camera 100 further generally has an internal processor (not shown) for controlling the functions of the camera 100, an image capturing device (not shown) such as a CCD for capturing digital photographs of the scene, and a storage device (not shown), such as a memory card or a CD for storing the captured images of the scene. The camera 100 further has a means for selectively storing the images of the scene, such as a button 104, depression of which instructs the processor to capture an image of the scene on the CCD and store the same on the storage device. The general operation of digital cameras is well known in the art, therefore, a description thereof is omitted for the sake of brevity. The camera 100 also typically has a flash 104 for illuminating the scene upon capturing the scene on the CCD or upon the command to do so (e.g., upon depressing the button 104). The camera 100 also has a plurality of buttons 108 for manipulating the captured images and magnifying the image on the LCD screen 102 as well as controlling various other functions.

Referring now to FIGS. 2a and 2b, there is shown the LCD screen 102 of the camera of FIG. 1. As discussed above, the LCD screen 102 is very useful for framing subjects or objects of interest in the scene. FIG. 2b illustrates a proper framing of two subjects 110, 112 in the scene. Once a user is satisfied with the framing of the subjects or objects in the scene, he or she then captures the image of the scene by depressing the button 104 as discussed above. However, in environments of poor ambient lighting, such as outdoors at night or in poorly lit indoor areas, the LCD screen 102 does not effectively display the scene. In such a situation, the user must depend on an approximation of whether or not the subjects or objects in the scene are properly framed. The user then depresses the button 104 and hopes for the best. However, such approximation is often very difficult, even for experienced photographers. Thus, the captured image of the scene taken in poor ambient lighting conditions is often improperly framed, such as that shown in FIG. 2a. Although, with a digital camera, a captured image that is not properly framed can be deleted and retaken, often the moment for a particular photograph has passed. At the very least, the taking, deleting, and retaking of photographs is annoying and time consuming.

### SUMMARY OF THE INVENTION

Therefore it is an object of the present invention to provide a digital camera that overcomes the disadvantages associated with digital camera of the prior art.

Accordingly, a still camera is provided. The still camera comprising: a display for displaying a scene; image pickup means for displaying a preview image of the scene on the display; a storage device operatively connected to the image pickup means; means for selectively storing the preview image on the storage device; and illumination means for illuminating the scene prior to storage of the preview image on the storage device where the ambient light level proximate the scene is less then that necessary to substantially view the preview image on the display.

The still camera preferably further comprises a flash for illuminating the scene while the preview image is being stored on the storage device. Preferably, the flash further operates as the illumination means.

The still image camera preferably further comprises: an ambient lighting detector for detecting the ambient light level proximate the scene; a processor for comparing the detected ambient light level to a predetermined light level and for operating the illumination means where the detected ambient light level is less than the predetermined light level, the predetermined light level being a sufficient illumination necessary to substantially view the preview image on the display.

Also provided is a method for operating a still camera. The method comprising: displaying a preview image of a scene on a display; selectively storing the preview image on a storage device; and illuminating the scene prior to storage of the preview image on the storage device where the ambient light level proximate the scene is less then that necessary to substantially view the preview image on the display.

The method preferably further comprises illuminating the scene while the preview image is being stored on the storage device. Preferably, the illuminating of the scene prior to storage of the preview image on the storage device comprises partially depressing a preview image storage button. Still more preferably, the illuminating of the scene prior to storage of the preview image on the storage device comprises partially depressing a preview image storage button and the illuminating of the scene while the preview image is being stored on the storage device comprises fully depressing the preview image storage button.

The method preferably further comprises: detecting the ambient light level proximate the scene; comparing the detected ambient light level to a predetermined light level; and operating the illumination means where the detected ambient light level is less than the predetermined light level, the predetermined light level being a sufficient illumination necessary to substantially view the preview image on the display.

Still provided is a still camera comprising: a display for displaying a preview image of a scene; a storage device for storing the preview image of the scene; and a light source for illuminating the scene prior to a command to store the preview image on the storage device.

Still provided is a still camera comprising: a display for displaying a scene; image pickup means for displaying a preview image of the scene on the display; a storage device operatively connected to the image pickup means; means for selectively storing the preview image on the storage device; and illumination means for illuminating the scene prior to storage of the preview image on the storage device where the ambient light level proximate the scene is less then a predetermined ambient light level.

Still provided is a still camera comprising: a display for displaying a scene; image pickup means for displaying a preview image of the scene on the display; a storage device operatively connected to the image pickup means; means for selectively storing the preview image on the storage device; and illumination means for illuminating the scene to permit a user to properly frame the scene on the display prior to storage of the preview image on the storage device.

Still yet provided is a still camera comprising: a display for displaying a scene; image pickup means for displaying a preview image of the scene on the display; a storage device operatively connected to the image pickup means; means for selectively storing the preview image on the storage device; and means for displaying the scene prior to storage of the preview image on the storage device where the ambient light level proximate the scene is less than that necessary to substantially view the preview image on the display.

The means for displaying the scene prior to storage of the preview image on the storage device can comprise an illumination means for illuminating the scene.

The means for displaying the scene prior to storage of the preview image on the storage device can comprise the display being sensitive to infrared radiation. In which case, the means for displaying the scene prior to storage of the preview image on the storage device can further comprise an infrared source for directing infrared radiation at the scene.

The means for displaying the scene prior to storage of the preview image on the storage device can comprise the display being sensitive to thermal radiation.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a rear view of a digital camera of the prior art having an LCD display.

FIGS. 2a and 2b illustrate the LCD display of the digital camera of FIG. 1 in which a scene is improperly and properly framed, respectively.

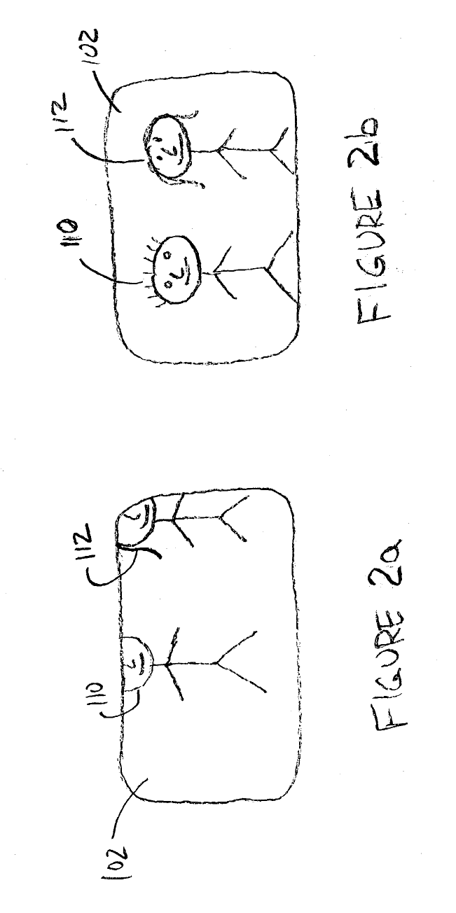

FIG. 3 illustrates a schematic electrical diagram of the digital camera of FIG. 1.

### DETAILED DESCRIPTION OF THE PREFERRED EMBODIMENT

Although this invention is applicable to numerous and various types of cameras, it has been found particularly useful in the environment of digital still cameras. Therefore, without limiting the applicability of the invention to digital still cameras, the invention will be described in such environment. For example, the methods and apparatus of the present invention can be used in a digital video camera which has a still camera capability or in a film camera having a preview feature.

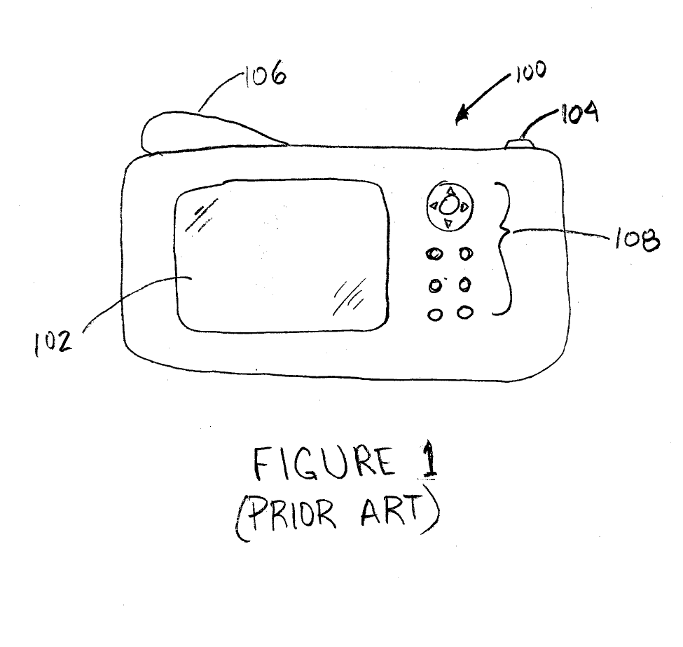

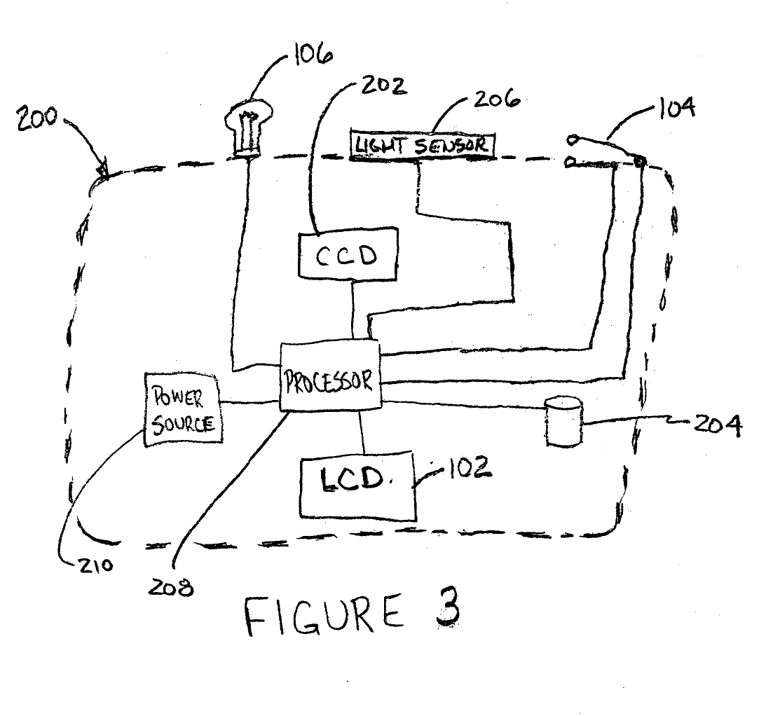

Referring now to FIG. 3, there is shown an electrical schematic illustration of a digital still camera according to a preferred implementation of the present invention, the digital still camera being referred to by reference numeral 200. In FIG. 3, like reference numerals from FIG. 1 are used to denote like features. As discussed above, the operation of digital cameras is well known in the art, thus a detailed description of the components thereof is omitted. The components shown are assumed to have the necessary hardware and/or software for proper operation of the digital camera.

The still camera 200 comprises a display 102 for displaying a scene. The camera 200 further has image pickup means, such as a CCD 202 for displaying a preview image of the scene on the display 102. The camera 200 also has a storage device 204 operatively connected to the image pickup means 202. The storage device 204 can be any storage means known in the art for use in digital cameras, such as a smart media card. The camera further has means for selectively storing the preview image on the storage device 204, such as a switch in the form of a preview image storage button 104. The camera 200 further has illumination means, such as a light source, for illuminating the scene prior to storage of the preview image on the storage device 204 where the ambient light level proximate the scene is less then that necessary to substantially view the preview image on the display 102. The illumination means can be a flash 106 that operates in a first capacity to illuminate the scene prior to storage of the preview image on the storage device 204 and in another capacity for illuminating the scene while the preview image is being stored on the storage device 204. Alternatively, an illumination means separate from the flash 106 can be provided to illuminate the scene prior to storage of the preview image on the storage device 204.

The camera 200 further can have an ambient lighting detector 206 for detecting the ambient light level proximate the scene. A processor 208 compares the detected ambient light level to a predetermined light level and operates the illumination means where the detected ambient light level is less than the predetermined light level. The predetermined light level is a sufficient illumination necessary to substantially view the preview image on the display. Thus, when the ambient light level is low and the scene cannot be discerned on the display 102, the processor 208 instructs the illumination means to illuminate the scene sufficiently such that the scene can be discerned on the display 102 and the scene can be properly framed before the scene is stored on the storage device (i.e., before a picture of the scene is taken). The processor 208 also controls the other elements and functions of the camera 200 and is powered by a power source 210, such as battery cells.

Where the flash 106 both illuminates the scene prior to storage of the preview image on the storage device 204 and illuminates the scene while the preview image is being stored on the storage device 204, the preview image storage button 104 can be used to operate both functions. When illuminating the scene prior to storage of the preview image on the storage device 204 the preview image storage button 104 can be partially depressed. If the detected ambient light level is less than the predetermined light level and the preview image storage button 104 is partially depressed, the processor instructs the flash to illuminate the scene. Instead of the illuminatin means flashing for a short time period, it is preferred that it remain on while the preview image storage button is being depressed such that the user can frame the scene properly in the display 102. Once the scene is satisfactorily framed, the preview image storage button can be fully depressed to operate the flash 106 in a typical manner to illuminate the scene while the scene is stored on the storage device 204. Although the ambient light sensor 206 is preferred, it is not necessary. For example, the user may decide when the illumination means is necessary and instruct the processor to operate the illumination means to illuminate the scene prior to storing the scene on the storage device 204 by partially depressing the preview image storage button 104 or operating another dedicated switch.

In an alternative embodiment, the display 102 (or an additional display (not shown)) can be of a type that is sensitive to infrared radiation. In such an embodiment, the scene can be viewed on the display with the infrared radiation normally given off by objects in the scene or the scene can be supplemented with infrared radiation from an infrared source and viewed on the display 102 prior to storage of the preview image on the storage device. The display can also be of a type that is sensitive to thermal radiation given off by objects in the scene. Displays for displaying thermal and infrared images of a scene are well known in the art.

Battery saving schemes may be implemented such that the illumination means does not drain the batteries too quickly. For instance, the illumination means may be powered to output only as much illumination necessary to achieve the predetermined light level. Furthermore, power to the illumination means can be intermittent or restricted to a predetermined period of time, such as a few seconds, so as not to drain the batteries. Still further, the lighting can be directed very narrowly to only illuminate the scene.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A still camera comprising:
a display for displaying a scene;
image pickup means for displaying a preview image of the scene on the display;
a storage device operatively connected to the image pickup means;
means for selectively storing the preview image on the storage device; and
illumination means for illuminating the scene prior to storage of the preview image on the storage device where the ambient light level proximate the scene is less than that necessary to substantially view the preview image on the display.

2. The still camera of claim 1, further comprising a flash for illuminating the scene while the preview image is being stored on the storage device.

3. The still image of claim 2, wherein the flash further operates as the illumination means.

4. The still image camera of claim 1, further comprising:
an ambient lighting detector for detecting the ambient light level proximate the scene;
a processor for comparing the detected ambient light level to a predetermined light level and for operating the illumination means where the detected ambient light level is less than the predetermined light level, the predetermined light level being a sufficient illumination necessary to substantially view the preview image on the display.

5. A method for operating a still camera, the method comprising:
displaying a preview image of a scene on a display;
selectively storing the preview image on a storage device; and
illuminating the scene prior to storage of the preview image on the storage device where the ambient light level proximate the scene is less than that necessary to substantially view the preview image on the display.

6. The method of claim 5, further comprising illuminating the scene while the preview image is being stored on the storage device.

7. The method of claim 5, wherein the illuminating of the scene prior to storage of the preview image on the storage device comprises partially depressing a preview image capture button.

8. The method of claim 6, wherein the illuminating of the scene prior to storage of the preview image on the storage device comprises partially depressing a preview image capture button and the illuminating of the scene while the preview image is being stored on the storage device comprises fully depressing the preview image capture button.

9. The method of claim 5, further comprising:
detecting the ambient light level proximate the scene;
comparing the detected ambient light level to a predetermined light level; and
operating the illumination means where the detected ambient light level is less than the predetermined light level, the predetermined light level being a sufficient illumination necessary to substantially view the preview image on the display.

10. A still camera comprising:
a display for displaying a preview image of a scene;
a storage device for storing the preview image of the scene; and
a light source for illuminating the scene prior to a command to store the preview image on the storage device.

11. A still camera comprising:
a display for displaying a scene;
image pickup means for displaying a preview image of the scene on the display;
a storage device operatively connected to the image pickup means;
means for selectively storing the preview image on the storage device; and
illumination means for illuminating the scene prior to storage of the preview image on the storage device where the ambient light level proximate the scene is less then a predetermined ambient light level.

12. A still camera comprising:
a display for displaying a scene;
image pickup means for displaying a preview image of the scene on the display;
a storage device operatively connected to the image pickup means;
means for selectively storing the preview image on the storage device; and
illumination means for illuminating the scene to permit a user to properly frame the scene on the display prior to storage of the preview image on the storage device.

12. A still camera comprising:
a display for displaying a scene;
image pickup means for displaying a preview image of the scene on the display;
a storage device operatively connected to the image pickup means;
means for selectively storing the preview image on the storage device; and
means for displaying the scene prior to storage of the preview image on the storage device where the ambient light level proximate the scene is less than that necessary to substantially view the preview image on the display.

13. The still camera of claim 12, wherein the means for displaying the scene prior to storage of the preview image on the storage device comprises an illumination means for illuminating the scene.

14. The still camera of claim 12, wherein the means for displaying the scene prior to storage of the preview image on the storage device comprises the display being sensitive to infrared radiation.

15. The still camera of claim 14, wherein the means for displaying the scene prior to storage of the preview image on the storage device further comprises an infrared source for directing infrared radiation at the scene.

16. The still camera of claim 12, wherein the means for displaying the scene prior to storage of the preview image on the storage device comprises the display being sensitive to thermal radiation.
